(19) United States
(12) Patent Application Publication
(10) Pub. No.: US 2006/0250820 A1
(43) Pub. Date: Nov. 9, 2006

(54) Reflection structure adapted for light guide panel

(76) Inventor: Heng-Sheng Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/123,695

(22) Filed: May 9, 2005

(51) Int. Cl. F21V 7/04

(52) U.S. Cl. 362/623

(57) ABSTRACT

A reflection structure, which is applied with at least one lighting module, includes a light guide panel and reflection frame. The light guide panel is injection molded and applied with the lighting module, which is disposed on at least one lateral side thereof. The reflection frame surrounds the light guide panel, and injection molded with high reflectivity.

### BACKGROUND OF THE INVENTION

1. Field of the Invention

The present invention relates to a reflection structure light guide panel, and particularly relates to a reflection structure adapted for a light guide panel with simplified steps.

2. Description of Related Art

A backlight module means a set that provides backlighting, and is applied broadly to various information, communication and consumption products, such as LCDs, film scanners, filmstrips or overhead projectors. The LCD field is the main application of the backlight module and has flourished recently, so that the components of the backlight module are becoming more and more important. How to reduce the costs of materials, shorten the time needed for assembly and improve the manufacturing efficiency are the main problems that need to be solved in this field.

The main components of the backlight module are a light source, a light guide, a reflection sheet, a diffusion sheet, a prism sheet, a brightness enhancement film and so on. The principle of the backlight module can be described simply as the light guide combined with a spontaneous light source, for example a CCFL or LEDs, to generate a large and evenly illuminated surface, the reflection sheet reflects the light scattered therefrom to the illuminated surface. The advantages of the backlight module are that it is lightweight, is highly illuminating, has excellent viewing angles and has a very light and simple structure. In general, during the backlight module assembly process, the spontaneous light source is faces the light guide. Apart from the illumination surface, the other faces of the light guide are attached with reflection sheets, which are provided to reflect the light at the bottom or the edge of the light guide in order to improve lighting efficiency.

With respect to FIGS. 1A and 1B, a conventional light guide structure of the first prior art, a light guide panel 1a is disclosed. An LED lighting module 2a is disposed at a lateral side of the light guide panel 1a, a reflection sheet 3a is covered over a bottom surface of the light guide panel 1a, and a CCFL 4a can be further disclosed and arranged opposite to the LED lighting module 2a. The arrangement of the CCFL 4a increases the lighting uniformity of the light guide panel 1a, and the reflection sheet 3a can further extend forwards the CCFL 4a and the LED lighting module 2a at two ends thereof respectively for enclosing the CCFL 4a and the LED lighting module 2a. In another embodiment, the reflection sheet 3a can be further extended to cover a flange part of a top surface of the light guide panel 1a. The light guide panel 1a can be defined with a cavity for receiving the CCFL 4a. Thus, the conventional light guide structure disclosed, can be further assembled with the diffusion sheet or the prism sheet as the backlight module. In detailed descriptions, the LED lighting module 2a includes a printed circuit board 20a and a plurality of LEDs 21a arranged on the printed circuit board 20a. For avoiding absorption of the light starting at the LEDs 21a from the printed circuit board 20a, (the extent of the absorption depends on the materials and the reflectivity of the printed circuit board 20a), the LED lighting module 2a is covered with a reflection member 22a facing the light guide panel 1a before being assembled with the light guide panel 1a.

In general practice, the step of covering the reflection member 22a is processed before the LED lighting module 2a is assembled with the light guide panel 1a. Regardless of the design or the quantity of the reflection sheet 3a, the single reflection member must be covered at least twice, once by the reflection sheet 3a and once by the reflection member 22a. In practice these two steps are not continuous and not smooth. When a complex design of the reflection sheet 3a or the reflection member 22a is provided, the corresponding time and labor waste much more than designs having single covers.

With respect to FIG. 2, a light guide for a backlight module according to a second prior art is disclosed. The light guide includes a light guide panel 1b, a CCFL 4b disposed at a lateral side of the light guide panel 1b, and a reflection film sputtered on a bottom surface of the light guide panel 1b. The light guide can be further assembled with a prism sheet or a diffusion sheet. This kind of light guide still needs extra reflection members when an LED lighting module is applied. The LED lighting module is covered with reflection member in advance, and then placed upon the light guide panel 1b. Before or after the LED lighting module is assembled with the light guide panel 1b, the bare sides of the light guide panel 1b will be covered with a reflection sheet to keep light from dissipating. Obviously, the equipment of the sputtering process requires much more time and costs more than the first prior art, and extra reflection sheets are necessary for the process thus incurring further costs and longer production times. Of course, the residual sides of the light guide panel 1b can be sputtered, but the sputtering process wastes too much time and labor to meet the needs of mass production.

### SUMMARY OF THE INVENTION

A reflection structure adapted for a light guide panel reduces the costs of guiding and reflecting light. Consideration is also given to simplifying and improving the efficiency of the process.

The reflection structure adapted for the light guide panel reduces optical loss via the contact between a light guide panel and a reflection frame, thereby increasing illumination.

A reflection structure, which is applied with at least one lighting module, includes a light guide panel and a reflection frame. The light guide panel is injection molded and applied with the lighting module, which is disposed on at least one lateral side thereof. The reflection frame surrounds the light guide panel, and is injection molded to give it highly reflectivity properties.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1A is a cutaway view of a first conventional light guide structure according to a first prior art;

FIG. 1B is a decomposition view of the first conventional light guide structure according to the first prior art;

FIG. 2 is a decomposition view of a second light guide according to a second prior art;

FIG. 3A is decomposition view of a reflection structure adapted for a light guide panel according to a first embodiment of the present invention;

FIG. 3B is side view of the reflection structure adapted for the light guide panel according to the first embodiment of the present invention;

FIG. 4A is decomposition view of the reflection structure adapted for the light guide panel according to a second embodiment of the present invention;

FIG. 4B is side view of the reflection structure adapted for the light guide panel according to the second embodiment of the present invention;

FIG. 5 is perspective view of the reflection structure adapted for the light guide panel according to another application of the present invention;

FIG. 6A is decomposition view of the reflection structure adapted for the light guide panel according to a third embodiment of the present invention;

FIG. 6B is side view of the reflection structure adapted for the light guide panel according to the third embodiment of the present invention;

FIG. 7A is decomposition view of the reflection structure adapted for the light guide panel according to a fourth embodiment of the present invention;

FIG. 7B is side view of the reflection structure adapted for the light guide panel according to the fourth embodiment of the present invention;

FIG. 8A is decomposition view of the reflection structure adapted for the light guide panel according to a fifth embodiment of the present invention; and

FIG. 8B is side view of the reflection structure adapted for the light guide panel according to the fifth embodiment of the present invention.

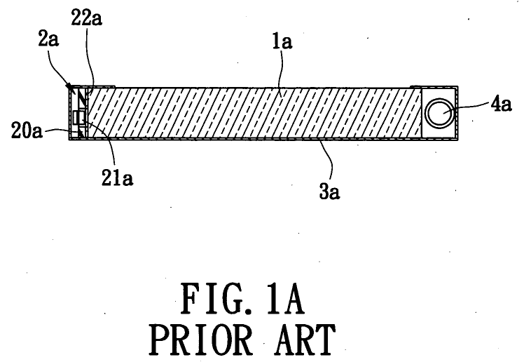

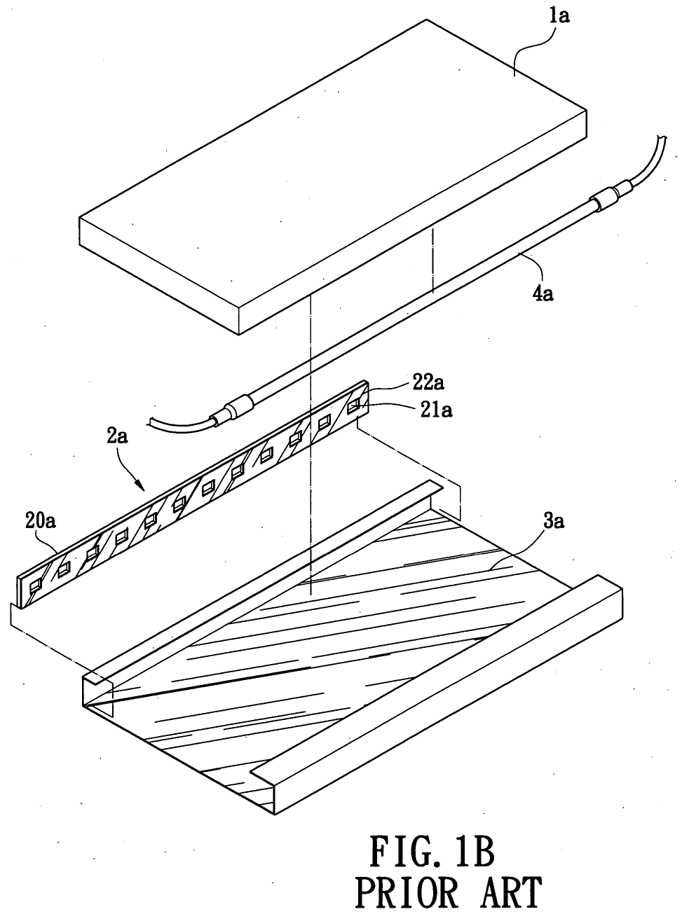

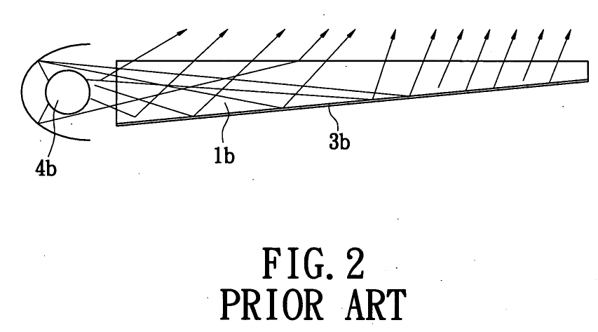

### DETAILED DESCRIPTION OF PREFERRED EMBODIMENTS

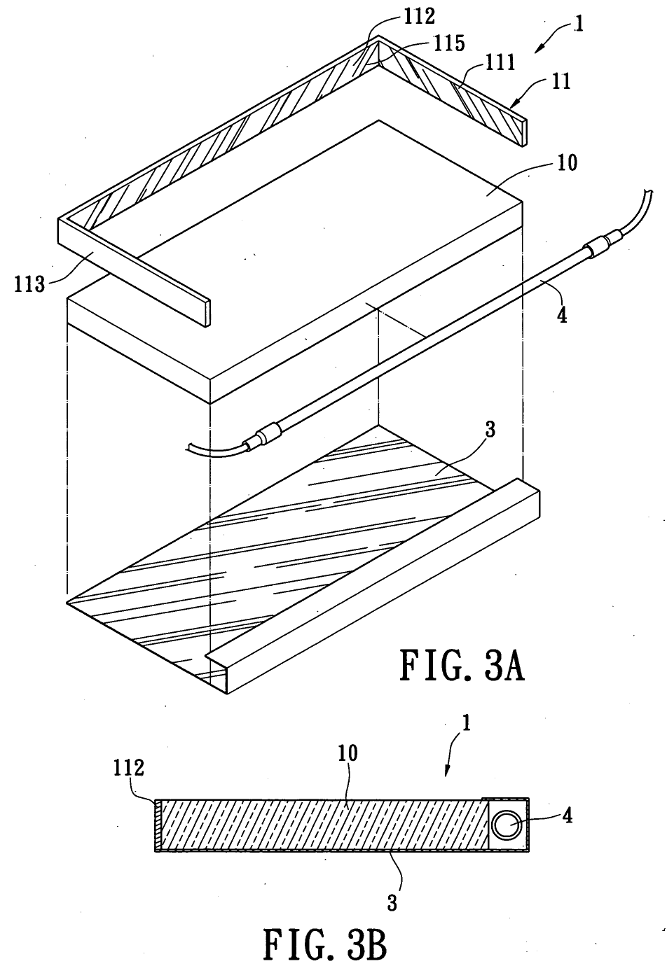

Referring to FIGS. 3A and 3B, a reflection structure 1, which is applied with at least one lighting module, is disclosed. The reflection structure 1 includes a light guide panel 10 and a reflection frame 11. The light guide panel 10 is injection molded and applied with the lighting module, which is disposed on at least one lateral side thereof, the light guide panel 10 can be foggy or transparent. The reflection frame 11 surrounds the light guide panel 10, and injection molded with high reflectivity; the reflection frame is white or silver. The reflection structure 1 further includes a reflection member 3, which can be a sheet or a film for part of the backlight module. In this embodiment, the reflection frame 11 includes three reflection strips 111, 112 and 113 connected one by one as a U shape and made integrally in one piece. The lighting module includes a lamp 4, for example, a CCFL, and the lamp 4 connects to U-shaped reflection frame 11 to enclose a border of the light guide panel 10 simultaneously.

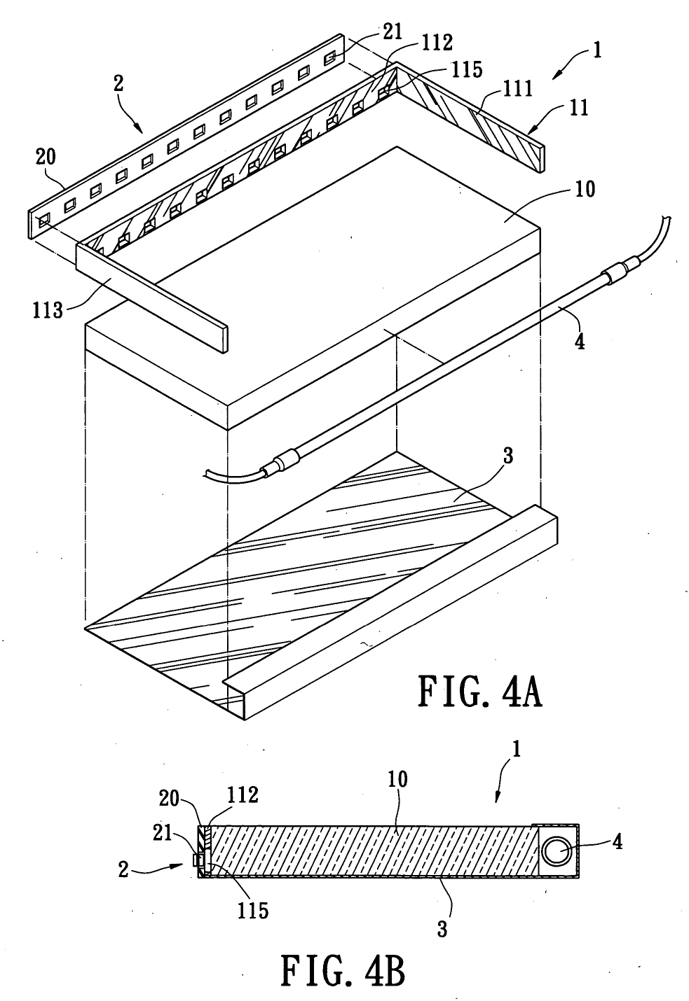

With respect to FIGS. 4A and 4B, the reflection frame 11 has three reflection strips 111, 112 and 113, the same as in FIG. 3A, and the lamp 4 connects to U-shaped reflection frame 11 to enclose a border of the light guide panel 10 simultaneously. The lighting module further includes a printed circuit board 20 contacted to a side of the reflection frame 11 and a plurality of LEDs 21 arranged on the printed circuit board 20, and the reflection frame 11 has a plurality of openings 115 corresponding to the LEDs 21. The printed circuit board 20 can contact at least one side of the reflection frame 11 and be opposite to the lamp 4 for improving illumination.

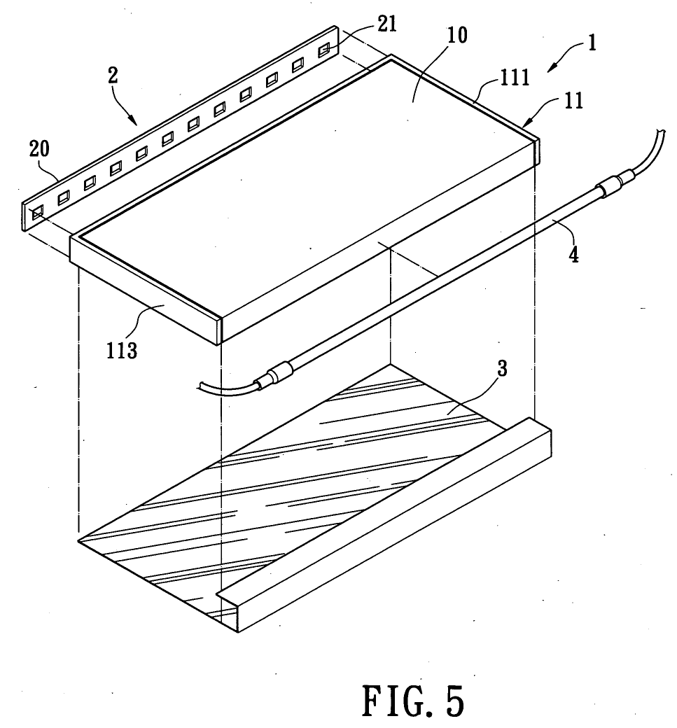

The processes for producing the light guide panel 10 and the reflection frame 11 are not limited. For example, the light guide panel 10 and the reflection frame 11 are made in one piece integrally as illustrated in FIG. 5. The method for producing an integral whole one can be bi-injection mold. Another method for assembly is that the light guide panel 10 and the reflection frame 11 are injected by a single mold respectively and then combined with each other, in FIGS. 3A, 4A, 6A and 8A. The light guide panel 10 contacts the reflection frame 11 closely in a tightly-fitting manner; the reflection frame 11 is injected to enclose the light guide panel 10 after the light guide panel 10 is made; or the light guide panel 10 and the reflection frame 11 are made by a single mold respectively and then contacted with each other by heat sealing for physical conjunction. The point is that there is no gap between the light guide panel 10 and the reflection frame 11 to reduce optical loss due to absorption by other materials, thereby improving illumination.

The light guide panel 10 and the reflection frame 11 are made of polymer materials, which include polycarbonate (PC), polyarylate (PAR) or polymethyl methacrylate (PMMA) materials. The light guide panel 10 and the reflection frame 11 are both made of the materials mentioned above, and further of other materials, but are formed using different proportions. The light guide panel 10 is transparent to promote the transference of light, and the reflection frame 11 can be white or silver, and is highly reflectivity.

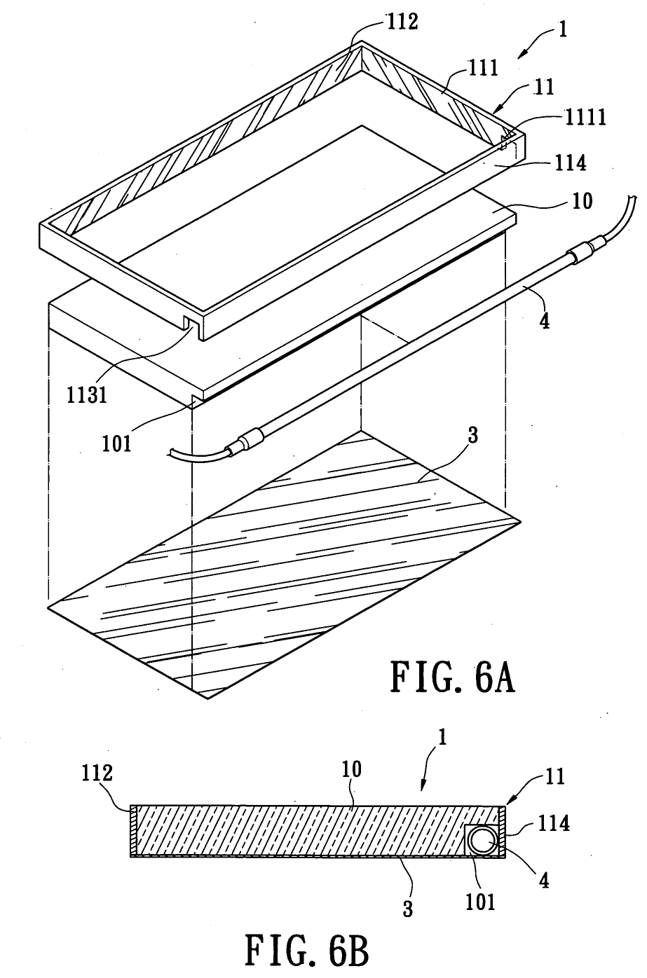

As illustrated in FIGS. 6A and 6B, the reflection frame 11 includes four reflection strips 111, 112, 113 and 114 connected one by one and circled in one piece integrally. According to this embodiment, the lamp 4 is adjacent to the reflection strip 114, the light guide panel 10 has a cutout 101 corresponding to the lamp 4 for reception. In FIG. 6A, the reflection strip 114 can keep the original thickness thereof, or the reflection strip 114 can shrink the thickness thereof for receiving part of the lamp 4. The reflection strips 113 and 111 have concaves 1131 and 1111 respectively for placing the lamp 4 at the cutout 101 easily.

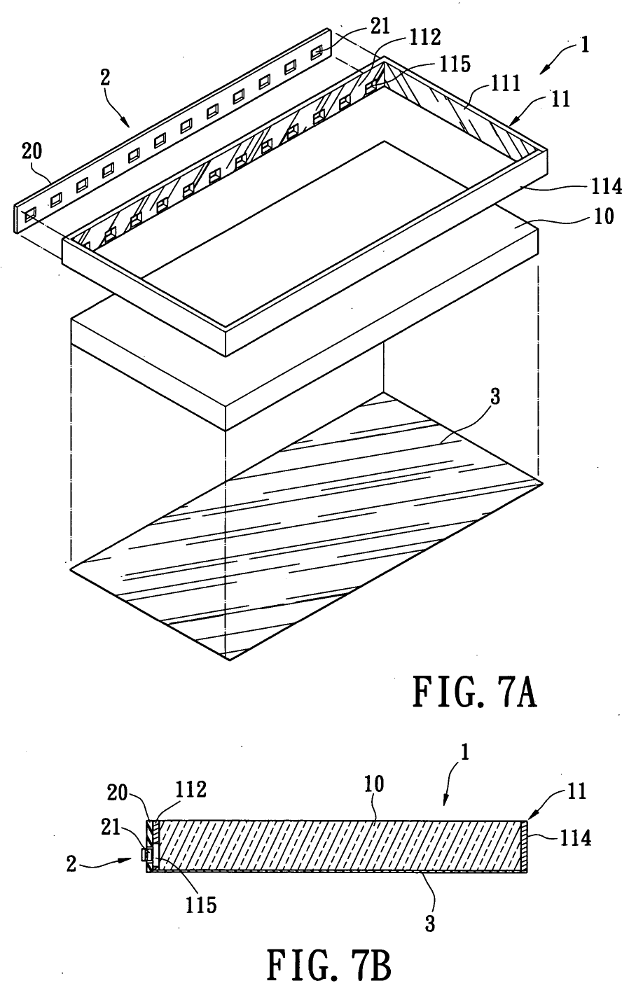

FIGS. 7A and 7b shows the lighting module, adapted for the reflection frame 11 with four reflection strips, further including a printed circuit board 20 contacted to a side of the reflection frame 10 and a plurality of LEDs 21 arranged on the printed circuit board 10, and the reflection frame 11 has a plurality of openings 115 corresponding to the LEDs 21.

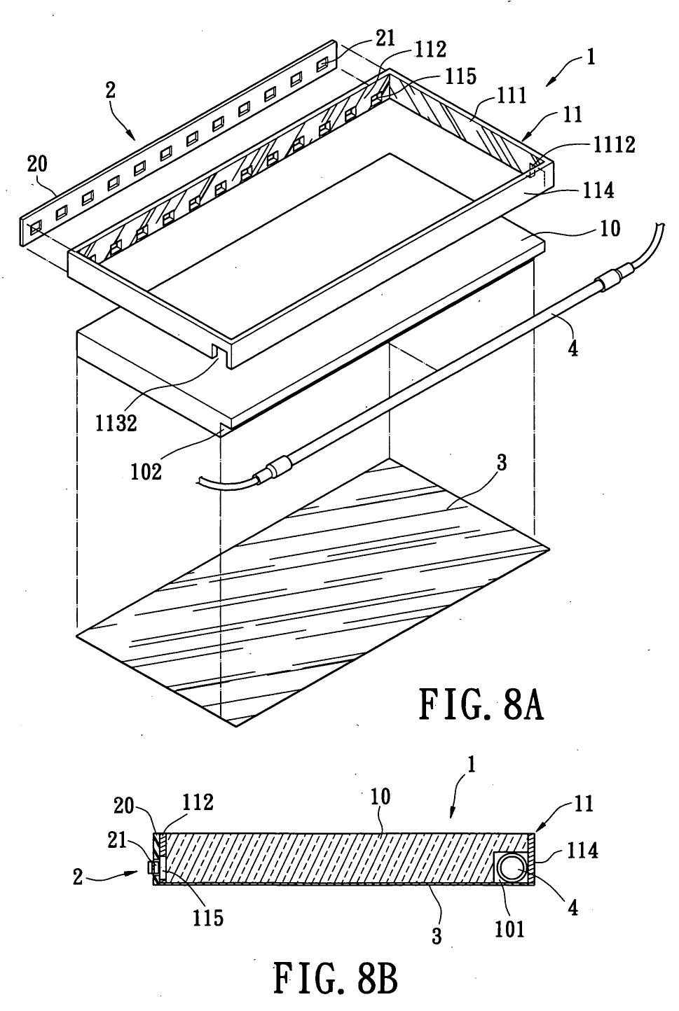

FIGS. 8A and 8B illustrates the printed circuit board 20 contacted to a side of the reflection frame 10 and a plurality of LEDs 21 arranged on the printed circuit board 10 on the basis of FIGS. 6A and 6B. The reflection frame 11 has four reflection strips 111˜114. The reflection frame 11 has a plurality of openings 115 corresponding to the LEDs 21. According to this embodiment, the lamp 4 is adjacent to the reflection strip 114, the light guide panel 10 has a cutout 101 corresponding to the lamp 4 for reception. In FIG. 8A, the reflection strip 114 keeps the original thickness thereof; or the reflection strip 114 shrinks the thickness thereof for receiving part of the lamp 4. The reflection strips 113 and 111 have concaves 1132 and 1112 respectively for placing the lamp 4 at the cutout 101 easily.

Compared to the first and second prior art, the first prior art requires large amounts of time and labor and engendering low efficiency. The second prior art is too expensive due to the sputter equipment for mass production; the larger the sputtered area is, the longer the production time.

According to the present invention, the advantages of the reflection structure are described as followed:

1. The reflection structure reduces the costs of guiding and reflecting light. It also simplifies the processes and improves the efficiency of production.

2. The reflection structure reduces optical loss via the contact between a light guide panel and a reflection frame, thereby increasing illumination.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A reflection structure applied with at least one lighting module and comprising:
a light guide panel injection molded and applied with the lighting module, which is disposed on at least one lateral side thereof; and
a reflection frame surrounding the light guide panel, injection molded with high reflectivity.

2. The reflection structure as claimed in claim 1, wherein the reflection frame is white or silver.

3. The reflection structure as claimed in claim 1, wherein the reflection frame includes three reflection strips connected one by one, U-shaped and made integrally in one piece.

4. The reflection structure as claimed in claim 3, wherein the lighting module includes a lamp, and the lamp connects to U-shaped reflection frame to enclose a border of the light guide panel.

5. The reflection structure as claimed in claim 4, wherein the lighting module further includes a printed circuit board contacted to a side of the reflection frame and a plurality of LEDs arranged on the printed circuit board, and the reflection frame has a plurality of openings corresponding to the LEDs.

6. The reflection structure as claimed in claim 5, wherein the lamp and the printed circuit board are opposite to each other.

7. The reflection structure as claimed in claim 1, wherein the reflection frame includes four reflection strips connected one by one and circled integrally in one piece.

8. The reflection structure as claimed in claim 7, wherein the lighting module further includes a printed circuit board contacted to a side of the reflection frame and a plurality of LEDs arranged on the printed circuit board, and the reflection frame has a plurality of openings corresponding to the LEDs.

9. The reflection structure as claimed in claim 8, wherein the lighting module includes a lamp.

10. The reflection structure as claimed in claim 9, wherein the lamp is disposed opposite to the printed circuit board.

11. The reflection structure as claimed in claim 9, wherein the light guide panel has a cutout corresponding to the lamp for reception.

12. The reflection structure as claimed in claim 7, wherein the lighting module includes a lamp.

13. The reflection structure as claimed in claim 12, wherein the light guide panel has a cutout corresponding to the lamp for reception.

14. The reflection structure as claimed in claim 14, wherein the light guide panel and the reflection frame are made integrally in one piece; the light guide panel contacts the reflection frame closely in a tightly-fitting manner; or the reflection frame is injected to enclose the light guide panel after the light guide panel is made.

15. The reflection structure as claimed in claim 14, wherein the light guide panel and the reflection frame are made by bi-injection as the light guide panel and the reflection frame are made integrally in one piece.

16. The reflection structure as claimed in claim 14, wherein the light guide panel and the reflection frame are made by single mold respectively and then tightly fitted together, or the light guide panel and the reflection frame are made by a single mold respectively and then contacted with each other by heat sealing.

17. The reflection structure as claimed in claim 1, wherein the light guide panel and the reflection frame are made of polymer materials.

18. The reflection structure as claimed in claim 17, wherein the polymer materials include polycarbonate (PC), polyarylate (PAR) or polymethyl methacrylate (PMMA) materials.
